(19) United States
(12) Patent Application Publication
(10) Pub. No.: US 2023/0324044 A1
(43) Pub. Date: Oct. 12, 2023

(54) Gas Control Valve For Electronic Pressure Control On A Gas Boiler

(71) Applicant: ebm-papst Landshut GmbH, Landshut (DE)

(72) Inventors: Martin HERTREITER, Loiching (DE); Enno Jan VROLIJK, Dalen (NL); Stephan WALD, Altenberge (DE); Markus WEINGART, Rottenburg (DE); Bernhard SIMON, Regensburg (DE); Alexander SCHNURR, Essenbach (DE); Plamen GEORGI, Altdorf (DE)

(21) Appl. No.: 18/129,395

(22) Filed: Mar. 31, 2023

(30) Foreign Application Priority Data
Apr. 4, 2022 (DE) 10 2022 107 984.8

(51) Int. Cl. F23N 1/02

(52) U.S. Cl. CPC F23N 1/022; F23N 2235/16; F23N 2241/04; F23N 2900/05181

(57) ABSTRACT

A gas control valve (1) has a central module (40), a control module (20) and a sensor module (30). Gas can flows through the central module (40) from a valve inlet (41) to a valve outlet (42). The control module (20) is directly on the central module (40) and controls a flow of the gas through the central module (40). A throttle element (23) is fluidically arranged between the valve inlet (41) and the valve outlet (42). The sensor module (30) is arranged directly on the central module (40) and has at least one sensor (31, 32) in operative connection with the gas flowing through the central module (40) through a gas inlet (44) fluidically arranged between the throttle element (23) and the valve outlet (42). In order to control the pressure, it detects a pressure difference between the gas flowing through the central module (40) and air having a reference pressure.

This application claims the benefit and priority of German Application No. 10 2022 107 984.8, filed Apr. 4, 2022. The entire disclosure of the above application is incorporated herein by reference.

### FIELD

The disclosure relates to a gas control valve such as is used in particular for electronic pressure control in gas boilers.

### BACKGROUND

Gas control valves for pressure control are known in the prior art and, for example, from the document DE 10 2018 102 866 A1. In gas boilers in which a gas-air mixture is burned, a gas control valve is used with respect to the gas upstream of a mixing device in which gas is mixed with air to form the gas-air mixture, and also upstream of a main flow restrictor, to set or control the gas volume flow flowing into the mixing device.

Furthermore, the prior art mostly provides that the pressure control is implemented by a single sensor and in particular a single differential pressure sensor, in particular an electrical differential pressure sensor, which determines the pressure difference or the differential pressure between the pressure of the gas at a first measuring point between gas control valve and main flow restrictor and the pressure of the air at a second measuring point which flows into the mixing device.

In addition to general pressure control, electronic zero-pressure control is also known in the prior art. Usually, it is provided that the gas control valve controls or adjusts the flow rate of the gas into the mixing device in such a manner that the pressure difference is zero, from which the term zero-pressure control derives.

The problem here is that such differential pressure sensors or other alternative sensors for determining the flow rate of the gas through the gas control valve and thus the pressure difference between gas and air must be calibrated in each case, and the entire control depends on the determined value.

In addition, such sensors are usually connected to the respective measuring points via comparatively long pressure lines, which leads to additional sources of error and a time-consuming and thus expensive assembly.

It is therefore the object of the disclosure to overcome the aforementioned disadvantages and to provide a gas control valve for electronic pressure control and, in particular, zero-pressure control, that can be used in a flexible and modular manner.

### SUMMARY

This section provides a general summary of the disclosure, and is not a comprehensive disclosure of its full scope or all of its features.

This object is achieved by the combination of features according to a gas control valve for electronic pressure control of a gas-air mixture at a gas boiler. The gas control valve comprises a central module, a control module and a sensor module. Gas can flow through the central module from a valve inlet to a valve outlet. The control module can be arranged directly on the central module and is designed to control a flow of the gas through the central module with a throttle element fluidically arranged between the valve inlet and the valve outlet. The sensor module can be arranged directly on the central module and has at least one sensor which is in operative connection with the gas flowing through the central module through a gas inlet fluidically arranged between the throttle element and the valve outlet and which, for controlling the pressure, is designed to detect a pressure difference between the gas flowing through the central module and air having a reference pressure.

Thus, according to the disclosure, a gas control valve for electronic pressure control, in particular zero-pressure control, of a gas-air mixture on a gas boiler is proposed. The gas control valve has a central module, a control module and a sensor module, wherein gas can flow through the central module from a valve inlet to a valve outlet. The control module can be or is arranged directly on the central module and is designed to control or adjust a flow of the gas through the central module. For this purpose, the control module has a throttling element which is fluidically arranged between the valve inlet and the valve outlet and which is in particular a valve cone cooperating with a valve seat. According to the disclosure, it is provided that the sensor module can be arranged directly on the central module and has at least one sensor which is in operative connection with the gas flowing through the central module through a gas inlet fluidically arranged between the throttle element and the valve outlet and which, for the purpose of pressure control or zero-pressure control, is designed to detect a pressure difference between the gas flowing through the central module and air having a reference pressure, for example as a differential pressure or as a mass flow.

A fundamental idea of the disclosure is therefore to tap the pressure for the sensor module in particular at the gas control valve or at the central module thereof and not outside the gas control valve, as is usually the case in the prior art. This significantly reduces line lengths and response times.

Accordingly, the gas control valve is preferably a unit with several modules which can be arranged on the central module and which can be exchanged if required, or due to damage or maintenance.

Furthermore, an advantageous variant provides that the sensor module has two sensors. If at least two sensors are provided, a redundant sensor system is available due to the two sensors, whereby the safety and accuracy of the measurement can be increased.

Furthermore, the values recorded by the sensors can be compared with each other and/or stored curves can be checked for plausibility and deviations can be compensated for so that the sensors do not have to be calibrated or at least do not have to be calibrated manually. In particular, deviations occurring over the service life of the sensors and, for example, slowly increasing deviations can be detected and compensated for or the sensors can be calibrated automatically.

An advantageous embodiment also provides that the at least one sensor is a mass flow sensor which is designed to detect the pressure difference by measuring a mass flow between the gas inlet and an air inlet of the sensor module that is in operative connection with the air.

Further, the at least one sensor can be a differential pressure sensor which is designed to detect the pressure difference by measuring a differential pressure between the gas flowing through the central module downstream of the control module and the air at an air inlet of the sensor module from which the gas-air mixture is formed.

If a second, or generally additional sensors are provided, the sensors can be of the same or a different type. Accordingly, if two sensors are provided, both sensors can be differential pressure sensors or mass flow sensors. Further, in the case of two sensors, one of the sensors can also be designed as a differential pressure sensor and the other one as a mass flow sensor, whereby the values determined for recording the flow rate are based on different measurement methods, so that safety can be further increased.

Moreover, a dust filter can be provided at the air inlet of the sensor module. As a result, the at least one sensor is protected from contamination and therefore the entire gas control valve becomes more robust and less prone to failure.

The sensor module can also directly include control electronics which is designed to determine an average value from the respective values measured by the two sensors and/or to compare the values measured by the sensors with one another and/or to check their plausibility. The plausibility check can be carried out by comparing the values with each other or with historical values. Furthermore, the control electronics can also directly control the control module and control the flow through the gas control valve by means of the throttle element.

In order to also be able to externally evaluate the values or status information of the at least one sensor or other components of the gas control valve detected by the at least one sensor, the gas control valve and, in particular, the sensor module can further include at least one communication interface via which, for example, the values, status information and/or error information detected by the sensors can be passed on to a higher-level controller of the gas boiler. Also, for example, calibration values, status and/or error information of the control module can be passed on through the communication interface.

In addition, the gas control valve and in particular the sensor module can have a voltage supply unit for supplying voltage to the control electronics and/or the at least one sensor. Although the voltage supply unit can be integrated into the sensor module, it can also be implemented alternatively on a main circuit board of boiler safety electronics or the boiler electronics of the gas boiler so that no installation space needs to be provided for this in the sensor module or within the housing of the sensor module.

Particularly preferably, the central module and the sensor module can have mutually corresponding mounting interfaces so that the sensor module can be fixed directly to the central module. In this case, the central module is provided with mounting interfaces, in particular on multiple sides, so that the sensor module can alternatively be fixed on each of the sides. As a result, the sensor module can be attached to different sides of the central module as required, so that a gas control valve adapted to different installation space requirements of different gas boilers can be provided in each case. The mounting interfaces which, for example, can be designed as screws, snap connectors, snap-in connectors or clamps also ensure quick and easy exchangeability of defective components. However, the sensor module does not necessarily have to be arranged directly on the central module but can be connected thereto, for example, by the fluid line mentioned below.

Preferably, it is also provided that the central module and the sensor module have mutually corresponding fluid interfaces through which the at least one sensor is in communication with the gas flowing through the central module downstream of the control module. The fluid interfaces can be directly connected to each other and/or via a fluid line. Thus, in the case of the direct connection, the fluid interface or the fluid interfaces of the sensor module are connected directly to the fluid interface or the fluid interfaces of the central module, which can be implemented, for example, by a latching of fittings through which a flow can pass. Since the fluid interfaces can also be connected to each other via a fluid line or, if required, several fluid lines, the sensor module can also be arranged spaced apart from the central module. Such fluid lines can be formed by flexible hoses or rigid lines, for example.

Furthermore, it is preferably provided that the fluid interface of the central module is connected to the gas inlet of the sensor module, which opens out downstream of the control module into a region of the central module through which gas flows. The inlet, or the position at which it opens out into the central module, forms the first measuring point already mentioned. In relation to a main flow restrictor optionally provided in the gas boiler, the inlet or the first measuring point is accordingly provided in particular downstream of the control module and upstream of the main flow restrictor and also inside the gas control valve. The inlet is in pressure connection with the gas and is shielded from the gas flow by a shielding which covers the inlet in the flow direction of the gas. Due to the shielding, the gas therefore does not flow directly past the inlet which accordingly is located in a flow-reduced region or in a shadow area of the flow, so that the value recorded by the sensors is not falsified.

Particularly preferably, the central module has a housing that has an opening downstream of the control module, which opening is covered by a cover. A seal is provided between the cover and the housing, with the shielding being formed by the cover and/or the seal.

The inlet itself can be provided in the cover or the housing, wherein the shielding can be formed not only by the cover or the seal, but alternatively by an additionally provided cover body or the housing itself.

In order to prevent damage to the sensor by condensate or moisture in general, the sensor module can further comprise at least one condensate drain. Such a condensate drain is designed to collect any condensate or moisture formed in the sensor module and, in particular, on the two sensors, and/or to discharge it from the sensor module. This allows the robustness and service life of the sensor module and accordingly of the entire gas control valve to be further increased. The condensate drain can be implemented by means of a sensor receptacle in which the sensors are arranged so that the moisture or condensate is led away from the sensors and cannot penetrate into one of the sensors.

In addition, the gas control valve can have a safety module which is arranged upstream of the control module on the central module and is designed to prevent the flow of gas through the central module in a blocking position and to release it in a passage position.

The features disclosed above can be combined in any desired manner as far as this is technically possible and they do not contradict one another.

Further areas of applicability will become apparent from the description provided herein. The description and specific examples in this summary are intended for purposes of illustration only and are not intended to limit the scope of the present disclosure.

### BRIEF DESCRIPTION OF DRAWINGS

Other advantageous developments of the disclosure are illustrated in the dependent claims or are described in more detail below together with the description of the preferred embodiment of the disclosure with reference to the figures.

FIG. 1 shows a schematic structure of a gas-air system of a gas boiler;

FIG. 2 shows a first variant of a gas control valve;

FIG. 3 shows a second variant of a gas control valve;

FIG. 4 shows a third variant of a gas control valve;

FIG. 5 shows schematic structure of a gas control valve.

### DETAILED DESCRIPTION

The figures are diagrammatic examples. Identical reference numerals in the figures indicate identical functional and/or structural features.

FIG. 1 shows schematically a part or a section of a gas boiler and more precisely the schematic structure of a gas-air system of a gas boiler, wherein a venturi mixer is shown as a mixing device 3 into which air is drawn by a blower 4 through an air inlet L from the environment with an air pressure p0. In the mixing device 3, the incoming air and a fuel (gas) flowing in through the fuel supply G are mixed to form a gas-air mixture.

The gas flowing in from the fuel supply G flows through a safety module 10 with a safety valve 11, a control module 20 with a valve 21 designed, for example, as a proportional valve, and the main flow restrictor 2. The safety valve 11 preferably has a passage position and a blocking position in which the flow of fuel through the safety valve 11 is blocked, wherein the safety valve 11 can be brought into the respective position by an actuator 12 of the safety module 10 provided for this purpose. Additionally or alternatively, the safety valve 11 can be operated manually or by hand. The valve 21 is designed to control the volume or mass flow of the gas, so that the gas to the mixing device 3 can be adjusted or controlled by the valve 21. By adjusting or regulating the valve 21, the mixing ratio of the gas-air mixture is thus adjustable. For this purpose, the valve 21 is connected to an associated actuator 22, for example a stepper motor, by means of which the flow position of the valve 21 can be changed or adjusted, wherein the actuator 22 is actuated with a manipulated variable by a control device, which is not shown, which can be integrated in the sensor module 30.

In the sensor module 30, two differential pressure sensors 31, 32 are provided in the specifically illustrated example, each of which is designed to determine the differential pressure between the pressure p2 of the gas upstream of the main flow restrictor 2 and downstream of the valve 21 as well as a reference pressure, the reference pressure preferably being the ambient pressure p0 or a pressure p1 of the air in an air-carrying supply line to the mixing device 3. However, as an alternative, it is also possible to provide only a differential pressure sensor 31, for example.

The gas-air mixture is conveyed by the blower 4 to a burner of the gas boiler, which is not shown, where the fuel-air mixture is to be burned.

In particular, the valve 21 of the control module 20 is set by the actuator 22 in such a manner that the sensor module 30 detects a pressure difference of 0 bar.

In addition to the first sensor 31 and the second sensor 32, the sensor module 30 in the present case also has control electronics 33, by means of which the differential pressures detected by the sensors 31, 32 are compared and checked for plausibility and a common differential pressure for controlling the valve 21 via the actuator 22 is determined.

In the present case, the safety module 10, the control module 20 and the sensor module 30 are provided on the central module 40 through which gas can flow from its valve inlet 41 to its valve outlet 42, so that these in their entirety form the gas control valve 1.

FIGS. 1 to 3 show a single gas control valve 1 in which the sensor module 30 is fixed to or connected to the central module 40 in different variants. This results in a high flexibility of the required installation space as well as a simple and fast exchangeability of the modules.

For this purpose, the central module 40 preferably has mounting interfaces, not shown, on each of its four sides around its longitudinal axis, which correspond to mounting interfaces of the sensor module 30, also not shown.

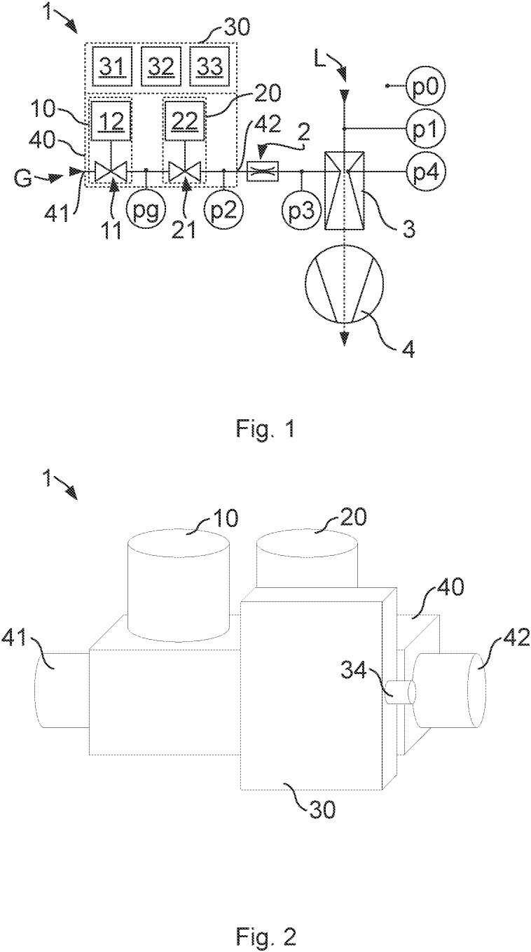

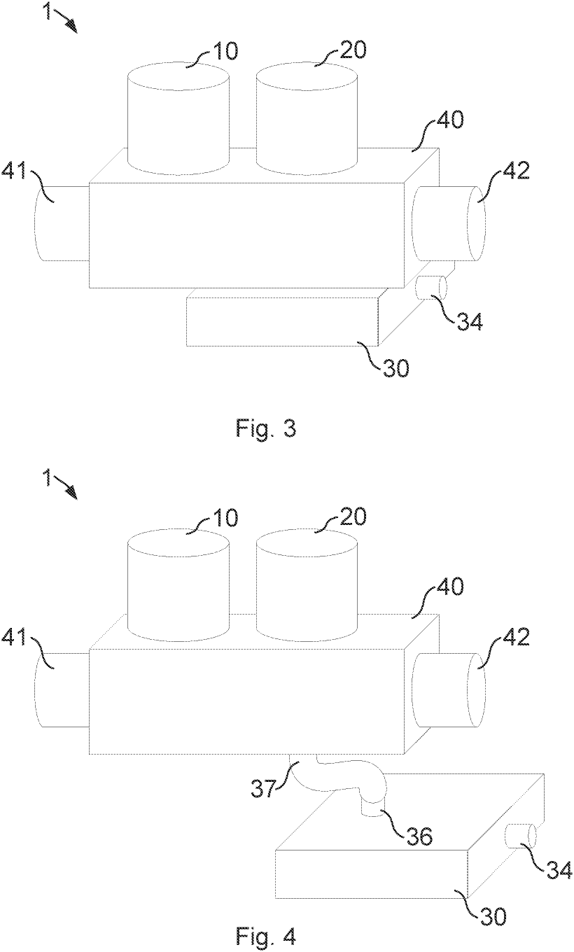

In the case of the gas control valve 1 according to FIG. 2, the sensor module 30 is arranged on a first side and, according to FIG. 3, on a second side orthogonal thereto. FIG. 4 further shows that the mutually corresponding fluid interfaces 36, 46 of sensor module 30 and central module 40 can alternatively be connected by a fluid line 37, so that the sensor module 30 according to the variant of FIG. 4 is not arranged directly on the central module 40 but is connected thereto in terms of pressure.

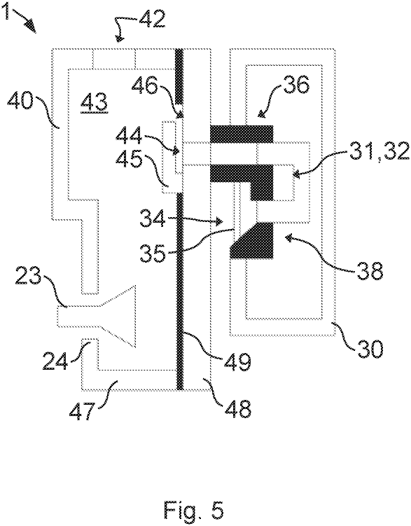

FIG. 5 shows a portion of the central module 40 and the sensor module 30 in cross-section.

A flow passes through the central module 40 from the valve inlet 41, not shown in FIG. 5, to the valve outlet 42, wherein the flow rate of the gas through the gas control valve 1 is adjustable or controllable by the throttle element 23 designed as a valve cone and the valve seat 24 of the control module 20. The sensor module 30, which is pressure-connected to the gas via the fluid interfaces 36, 46, is designed in this case for electronic pressure control or for detecting the pressure difference between the gas and the surrounding air. For this purpose, the sensor module 30 has an air inlet 34 at which a dust filter 35 is provided to prevent dirt particles from penetrating into the sensor module 30. Furthermore, a condensate drain 38 is provided at the air inlet 34, by means of which condensate produced at the sensors 31, 32 can be discharged through the air inlet 34 and into the environment.

A gas inlet 44 of the sensor module 30, which opens out into the region 43 of the central module 40 through which gas flows, is provided at the fluid interface 46 of the central module 40, wherein the gas inlet 44 is covered by a shielding 45 in the direction of flow, i.e. towards the valve outlet 42.

The housing 47 of the central module 40 has an opening in the region 43 which is closed by a cover 48, wherein the cover 48 integrally forms the shielding 45.

Alternatively, however, a seal 49 provided between the housing 47 and the cover 48 or a separate component can also form the shielding 45.

Due to the shielding 45, the inlet is located in a flow-reduced region, so that no or at least lower pressure fluctuations occur at the sensors 31, 32 in the sensor module 30.

The disclosure is not limited in its embodiment to the preferred exemplary embodiments indicated above. Rather, a number of variants which make use of the presented solution, even in fundamentally different embodiments, is conceivable.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A gas control valve for electronic pressure control of a gas-air mixture at a gas boiler,
wherein the gas control valve comprises a central module, a control module and a sensor module,
gas can flow through the central module from a valve inlet to a valve outlet,
the control module can be arranged directly on the central module and is designed to control a flow of the gas through the central module with a throttle element fluidically arranged between the valve inlet and the valve outlet,
the sensor module can be arranged directly on the central module and has at least one sensor which is in operative connection with the gas flowing through the central module through a gas inlet fluidically arranged between the throttle element and the valve outlet and which, for controlling the pressure, is designed to detect a pressure difference between the gas flowing through the central module and air having a reference pressure.

2. The gas control valve according to claim 1,
wherein the at least one sensor is a mass flow sensor and is designed
to detect the pressure difference by measuring a mass flow between the gas inlet and an air inlet of the sensor module which is in operative connection with the air.

3. The gas control valve according to claim 1,
wherein the at least one sensor is a differential pressure sensor and is designed to detect the pressure difference by measuring a differential pressure between the gas flowing through the central module downstream of the control module and the air at an air inlet of the sensor module from which the gas-air mixture is formed.

4. The gas control valve according to claim 2,
wherein a dust filter is provided at the air inlet of the sensor module.

5. The gas control valve according to claim 1,
wherein the sensor module has two sensors.

6. The gas control valve according to claim 5,
wherein the sensor module has control electronics designed to determine an averaged value from the respective values measured by the sensors and/or to compare the values measured by the sensors and/or to check their plausibility.

7. The gas control valve according to claim 6,
wherein the control electronics has at least one communication interface and/or a voltage supply unit for supplying voltage to the control electronics and/or the sensors.

8. The gas control valve according to claim 1,
wherein the central module and the sensor module have mutually corresponding interfaces and the sensor module can be fixed directly to the central module,
and the central module provides mounting interfaces, in particular on multiple sides, and the sensor module can alternatively be fixed to each of the multiple sides.

9. The gas control valve according to claim 1,
wherein the central module and the sensor module have mutually corresponding fluid interfaces through which the at least one sensor is in communication with the gas flowing through the central module downstream of the control module,
wherein the fluid interfaces can be connected to one another directly and/or via a fluid line.

10. The gas control valve according to claim 9,
wherein the fluid interface of the central module is connected to the gas inlet which opens out downstream of the control module into a region of the central module through which gas flows,
wherein the gas inlet is in operative connection with the gas and is shielded from the gas flow by a shielding which covers the gas inlet in the direction of flow of the gas.

11. The gas control valve according to claim 10,
wherein the central module has a housing which has an opening downstream of the control module, which opening is covered by a cover,
wherein a seal is provided between the cover and the housing,
and wherein the shielding is formed by the cover and/or the seal or a shielding body.

12. The gas control valve according to claim 1,
wherein the sensor module has at least one condensate drain which is designed to collect a condensate forming in the sensor module and, in particular, at the at least one sensor and/or to discharge it from the sensor module.

13. The gas control valve according to claim 1,
wherein the gas control valve has a safety module arranged downstream of the valve inlet and upstream of the control module on the central module and is designed to prevent the flow of gas through the central module in a blocking position and to release it in a passage position.
